(19) United States
(12) Patent Application Publication
(10) Pub. No.: US 2017/0296989 A1
(43) Pub. Date: Oct. 19, 2017

(54) A CO-ROTATING SELF-CLEANING TWO SCREW EXTRUDER WITH AN INTERNAL BAFFLE

(71) Applicant: Guangdong Industry Technical College, Guangdong (CN)

(72) Inventors: Baiping Xu, Guangdong (CN); Huiwen Yu, Guangdong (CN); Ping Kong, Guangdong (CN); Lixuan Wu, Guangdong (CN); Jiangang Li, Guangdong (CN); Meigui Wang, Guangdong (CN)

(73) Assignee: Guangdong Industry Technical College, Guangdong (CN)

(21) Appl. No.: 15/310,297

(22) PCT Filed: Dec. 28, 2015
(86) PCT No.: PCT/CN2015/099285

§ 371 Date: Nov. 10, 2016

(30) Foreign Application Priority Data
Dec. 29, 2014 (CN) 201410837490.0

(51) Int. Cl. B01F 7/00; B01F 7/08; B01F 15/00

(52) U.S. Cl. CPC B01F 7/00808; B01F 15/00019; B01F 7/00416; B01F 7/006; B01F 7/082

(57) ABSTRACT

A self-cleaning extruding apparatus with two co-rotating screws and the method thereof are provided here. Said apparatus is comprised of a screw mechanism, a barrel (1), a feeding port (10), a venting port (11), and a discharge port (12). Said screw mechanism is comprised of the first screw with one tip (3) and the second screw with two tips (4). There is a baffle in the channel of the first screw and the baffle's height is lower than that of the screw flight. The baffle will cause hyperbolic perturbation in the shape of a ‘figure 8’ flow pattern above the top of the baffle. The first and second screws rotate at the same speed and touch each other at all times, thereby achieving a self-cleaning function.

The baffle will generate chaotic mixing in the screw channel caused by the hyperbolic perturbation. Topological chaos is also introduced into the screw channel by the mechanism ‘one part divided into two parts, then two parts converging into one part, and then one part divided into two parts once more’. Each of the screws in the present invention uses an asymmetrical flow channel geometrical shape, such that a periodic action like ‘compression—expansion—further compression—expansion further’ works. The above three enhancement mechanisms work together to efficiently accelerate melting and mixing.

### TECHNICAL FIELD

The present invention relates to a processing technique for extrusion by two screws, particularly a co-rotating, self-cleaning extruder with two screws, one of which has an internal baffle, and the processing method thereof.

### BACKGROUND ART

Twin screw extruders, which have an excellent self-cleaning function, are popular devices of mixing and melt compounding. This type of apparatus is composed of the barrel and two identical screws that are arranged in parallel along the axis of the barrel. In order to improve mixing, multi-tip configurations are frequently used to generate different flow topology paths. For example, conventional twin screw extruders with two tips are commonly used. From the point of view of the topology, this configuration will generate three separate independent flow channels, but the materials in the different channels cannot mix with one another. Thus when a fluctuation in feed content appears, it also causes a fluctuation in product quality. Only in the kneading mixing sections can the materials from different screw channels mix together. However, such structures will lead to a very high shear rate, stagnation, abrupt increase in energy consumption, and the existence of a dead zone, and will cause a degradation and reduction in the self-cleaning function.

On the other hand, because of the intermeshing movement of the screws, using a multi-tip screw configuration will result in a decrease in the screw channel depth, thus decreasing the throughput. Since conventional twin screws have the same geometrical shape and same space in flow channels, no asymmetry break-up effect is introduced in the flow channels. It is commonly accepted that the nip region plays a significant role in mixing enhancement. Moreover, there is no elongation action owing to nearly the same channel volume, which is necessary for melting and dispersive mixing for polymer materials. In addition, the screw channels are always partially filled during normal operation, thus the nearly constant cross-section of the flow channel in the conventional twin screw extruder will result in a reduction in the efficiency of melting and mixing. Therefore, a high speed is required to achieve the high shear rate, and a very large screw length-to-diameter ratio is needed to extend the residence time. Thus, the requirements of high throughput and good mixing are both met for current engineering applications. However, all of these measurements will cause many problems such as huge energy consumption, lower efficiency, degradation of materials, and so on.

### CONTENTS OF THE INVENTION

The primary purpose of the present invention is to overcome the abovementioned defects and deficiencies associated with the current technology by providing a self-cleaning, plasticizing, and extruding apparatus with co-rotating two screws, one of which has an internal baffle. This apparatus materializes the advantages of chaotic mixing, topology chaos, and the action of the elongation force field to improve the processing efficiency and degree of mixing effectively.

Another purpose of the present invention is to provide a self-cleaning, plasticizing, and extrusion method with co-rotating two screws, one of which has an internal baffle, carried out by the abovementioned apparatus.

The purposes of the present invention are carried out by the following technical solutions: a co-rotating, self-cleaning extruder with two screws, one of which features an internal baffle, comprising a screw mechanism and a barrel. Said screw mechanism is located horizontally inside of the barrel and is comprised of the first and second screw, which intermesh with each other. The first screw has one tip and the second screw has two tips. The first screw has an internal baffle mounted in the screw channel and the baffle's height is lower than the depth of the screw channel. The channel of the first screw will generate a hyperbolic manifold in the shape of a figure ‘8’ just above the vicinity of the baffle. The first and second screws rotate at the same speed and keep engaging with each other all the time. The first screw surface, including the baffle, and the second screw surface can achieve the self-cleaning function.

Since the first and second screws are all tangent to the inner wall of the barrel, the flow channels are formed between the first and the second screws and the inner wall of the barrel. The cross-sectional curves of the first and the second screw consist of several arcs of different radii while the number of arcs of each screw is the same.

As a preferred solution, say the first and second screws consist of 8 arcs. The arcs of the first screw are M₁M₂, M₂M₃, M₃M₄, M₄M₅, M₅M₆, M₆M₇, M₇M₈, and M₈M₁, in turn; and for the second screw, N₁N₂, N₂N₃, N₃N₄, N₄N₅, N₅N₆, N₆N₇, N₇N₈, and N₈N₁.

The arc M₁M₂ is engaged with the arc N₁N₂, correspondingly, M₂M₃ with N₂N₃, M₃M₄ with N₃N₄ , M₄M₅ with N₄N₅, M₆M₇ with N₆N₇, M₇M₈ with N₇N₈, and M₈M₁ with N₈N₁.

Within the variation of the z position of the baffle, the polar angle of the baffle either keeps constant or varies periodically; similarly, the baffle's height also remains constant or changes periodically (see below).

(1) The rotation center of said first screw is O₁, arc M₅M₆ corresponds to the baffle, the polar angle degree of the baffle experiences cyclic or non-cyclic changes, and the polar angle degree is the angle between the centerline of the baffle O₁A and the axis O₁M₃.

(2) Within the first screw, the height of said baffle is constant, or experiences cyclic changes with an increase of the corresponding axial position. The inner cavity of said barrel consists of two cylinder grooves which are communicated, whose cross-sections appear to be a hole with a ‘figure 8’ shape.

According to the motion direction of the materials to be processed, the inner section is divided into a solid conveying zone, melting zone, venting zone, and mixing and metering zone, and said feeding port is provided above the barrel of the solid conveying zone. Said venting port is provided above the barrel of said venting zone. Said discharge port is provided at the end of the barrel.

The self-cleaning and extruding method by two co-rotating screws with an internal baffle carried out by the above-mentioned apparatus is comprised of the following steps.

(1) After the materials enter the barrel from the feeding port, the first and second screws co-rotate along their own axes. When the materials enter the solid conveying zone, the feed materials are pushed forward partially under the positive displacement of the first and second screw and partially by friction forces from the first and second screw, so that the materials move toward the melting zone. At the same time, the mixing of components from the first and second screws is achieved due to the action of the baffle in the first screw.

(2) When the materials move to the melting zone, heat transfer is enhanced due to the stir action of the baffle in the first screw channel. Compression action is exerted on the materials and pre-melting is achieved via the compression energy of the second screw. Meanwhile, friction heat is generated by the high speed rotation of each of the screws and, at the same time, the external heat is conducted through the barrel.

Topological chaos is also introduced into the screw channel by the mechanism ‘one part divided into two parts, then two parts converging into one part, and then one part divided into two parts once more’. In addition, the cross section of the flow channel will undergo an expansion—compression—expansion action, and the separation of the melt from the solids will be accelerated. At the same time, the baffle in the first screw will cause hyperbolic flow perturbation of the ‘figure 8’ to generate chaotic mixing. All of these actions work together to accelerate the melting process so that the materials melt efficiently.

(3) When the melt enters the venting zone, the single one-flow channel in the first screw communicates with the two independent channels separated by the screw flight in the second screw, so that the surface area of venting increases. Furthermore, the stir action of the first screw, and the compression and expansion action of the second screw, will accelerate gas to discharge from the venting port, allowing the melt to move further toward the discharging port.

(4) When the melt enters the mixing and extruding zone, the melt is subjected to the topological chaos that resulted from the flow channel, which consists of two screws and a barrel, where the action of “one part divided into two parts, then two parts converging into one part, and then one part divided into two parts once more” is in effect. The baffle in the first screw channel will induce hyperbolic perturbation of the ‘figure 8’ to generate global chaotic mixing throughout the whole screw channel. In addition, the periodic compression action will lead to elongational flow. All three of these effects will improve the mixing and plasticating of the materials so that the melt is stably extruded from the discharging port. At the same time, a self-cleaning effect is achieved by the inter-wiping effect between each of the screws.

The present invention has the following advantages and beneficial effects as compared with the prior art.

1. In the present invention, the first screw is a one-tip screw with an internal baffle. In contrast, the second screw has two tips. The two screws rotate at the same speed and engage with each other. This leads to an efficient improvement in eliminating the quality fluctuation caused by the content fluctuation of fed raw materials. Furthermore, such a combination also takes advantage of the powerful conveying ability of the one-tip screw, thereby increasing the efficiency of solid conveying and the output to a large extent to meet the sizable output requirements.

2. Three mechanisms of mixing enhancement have been realized. (1) Global chaotic mixing is introduced by the hyperbolic perturbation of the resulting ‘figure-8’-shaped flow manifold caused by using the baffle. (2) The flow topology formed by the two screws and the barrel can cause topological chaos like ‘one part is divided into two parts, then two parts converge into one part, and then one part is again divided into two parts, and so one.’ (3) The periodic action like ‘compression—expansion—further compression—further expansion’ is introduced into the flow channel between the two screws to achieve the elongational flow field. The compression preheat and dispersive mixing can also be achieved so that the mixing and heat transfer are enhanced significantly as a result of a shorter heating and processing history and lower energy consumption.

3. The present invention uses an inter-wiping effect between the first screw and the second screw to carry out a self-cleaning effect during the processing process.

4. The present invention uses an internal baffle and is especially suitable for the partial fill of the screw channel during the course of processing. The elongational effect existing in the flow channel can increase the distributive and dispersive mixing so significantly that nearly no kneading discs are required and better self-cleaning can be achieved along with a much narrower residence time distribution. Thus, the present invention is especially suitable for high throughput processing and for using nanomaterials as fillers.

### DESCRIPTION OF ACCOMPANYING DRAWINGS

FIG. 1 is a structural schematic diagram of embodiment 1 in the present invention.

FIG. 2 is an enlarged structural schematic diagram of embodiment 1 cut along E-E in FIG. 1.

FIG. 3 is an enlarged structural schematic diagram of embodiment 1 cut along F-F in FIG. 1.

FIG. 4 is a three-dimensional structural schematic diagram of the screw mechanism and partial barrel in embodiment 1.

FIG. 5 is the first principle schematic diagram of achieving chaotic mixing, topological chaos, and elongation action in embodiment 1.

FIG. 6 is the second principle schematic diagram of achieving chaotic mixing, topological chaos, and elongation action in embodiment 1.

FIG. 7 is the third principle schematic diagram of achieving chaotic mixing, topological chaos, and elongation action in embodiment 1.

FIG. 8 is a structural schematic diagram of the cross-section of the screw mechanism and partial barrel in embodiment 2.

FIG. 9 is a three-dimensional structural schematic diagram of the screw mechanism and partial barrel in FIG. 8 of embodiment 2.

FIG. 10 is a three-dimensional structural schematic diagram of the screw mechanism and partial barrel in embodiment 6.

### PARTICULAR EMBODIMENTS

The present invention is further described in detail below by incorporating the embodiments and drawings, but the embodiments of the present invention are not limited thereto.

### Embodiment 1

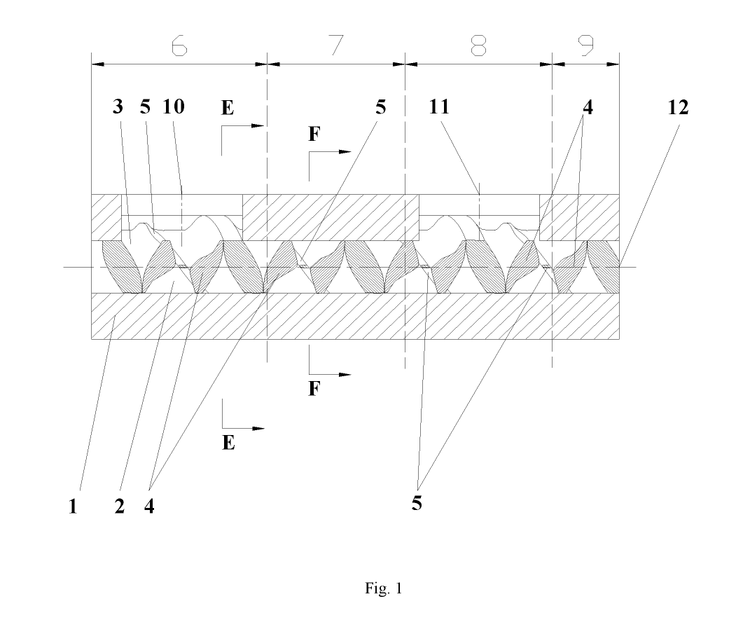

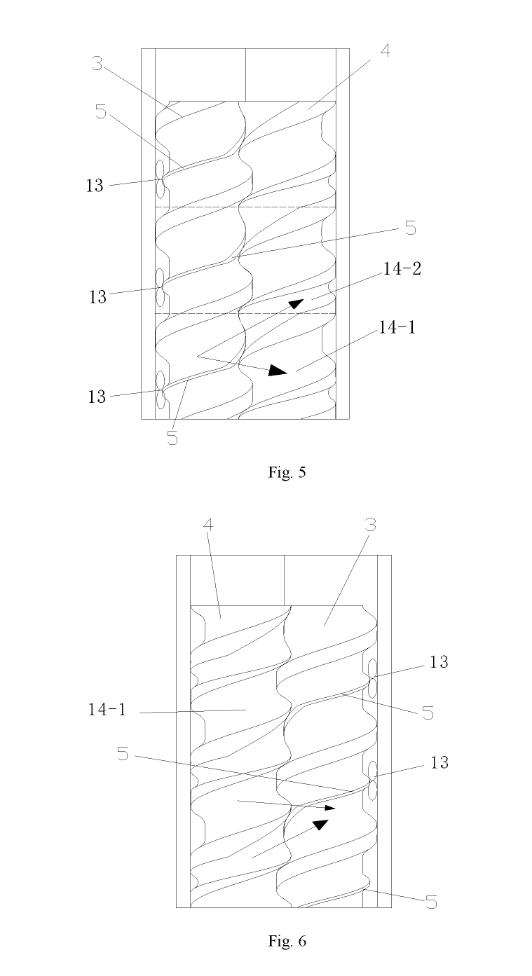

As shown in FIGS. 1 through 7, the co-rotating, self-cleaning two-screw extruder with internal baffle is comprised of a screw mechanism and a barrel (1). Said screw mechanism is contained inside the inner section (2) of the barrel (1), and placed horizontally. Said screw mechanism is comprised of the first screw (3) and the second screw (4); the axis of the first screw (3) and the second screw (4) are coincidental with that of the barrel (1). The first screw (3) is a one-tip configuration, while the second screw (4) is a two-tip configuration. The first screw has an internal baffle (5), which is lower than the screw flight and causes the hyperbolic perturbation of the ‘figure 8’ shaped flow manifold as shown in FIGS. 5-7. The first screw (3) and the second screw (4) co-rotate at the same speed and touch each other. The first screw and the baffle achieve the self-cleaning function with the channel of the second screw, and the second screw achieves the self-cleaning function with the channel of the first screw. The contour lines of the threads of the first screw (3) and the second screw (4) are tangent to the inner wall of the barrel (1). The flow channel is formed between the outer sides of the first and second screws and the inner side of the barrel. The cross-section counters of the first and second screws are comprised of several circle arcs of different radii, and the number of circle arcs of the first screw and the second screw are the same. As shown in FIG. 4, the inner cavity of the barrel consists of two cylindrical grooves that are communicated, whose cross-sections appear as the hole with the ‘figure 8’ shape.

According to the motion direction of the materials to be processed, the inner section of the barrel (1) is divided into a solid transporting zone (6), a melting zone (7), a venting zone (8), and a mixing and extruding zone (9). The feeding port (10) is located above the barrel (1) of the solid transporting zone (9). The venting port (11) is located above the barrel (1) of the venting zone (11). Both the feeding port (10) and the venting port (11) are communicated with the barrel (1). The discharging port (12) is located at the end of the barrel (1).

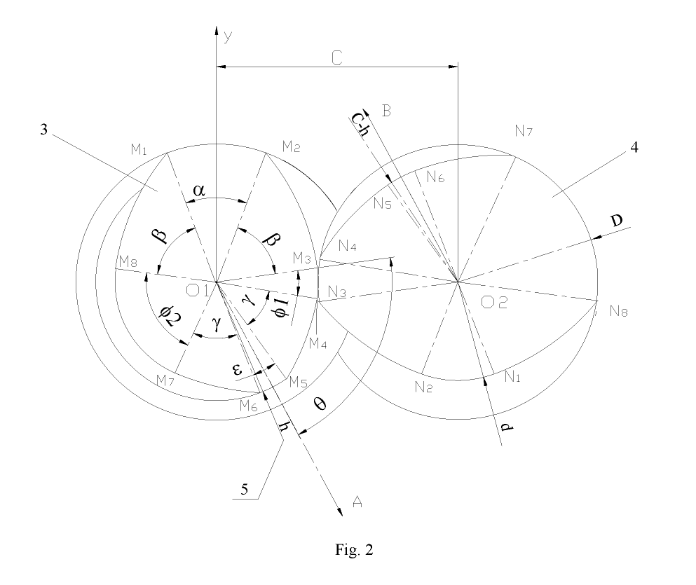

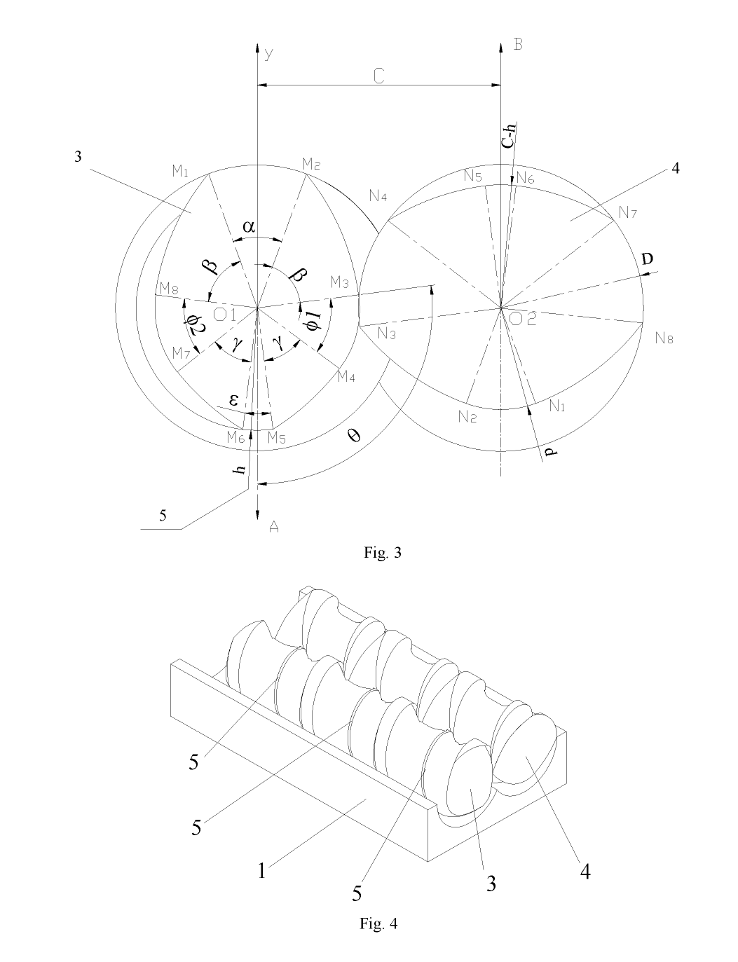

The structure described above is shown in FIGS. 2 and 3. The cross-sections of the first and second screws are comprised of 8 circle arcs; the 8 arcs of the first screw are M₁M₂, M₂M₃, M₃M₄, M₄M₅, M₅M₆, M₆M₇, M₇M₈, and M₈M₁, and those of the second screw are N₁N₂, N₂N₃, N₃N₄, N₄N₅, N₅N₆, N₆N₇, N₇N₈, and N₈N₁. M₁M₂ is engaged with N₁N₂, M₂M₃ with N₂N₃, and so on.

Therein, arc M₁M₂ is tangent to the inner cavity (i.e., arc M₁M₂ is the outer curve of the first screw) and its corresponding central angle is α, which is symmetrical about the polar axis O₁y. For the convenience of expression, the first screw (3) and the second screw (4) are simultaneously rotated at an equal angle so that the axis O₁y is always points north. It follows that for different axial positions z, the arc M₈M₁, M₁M₂, and M₂M₃ in the first screw will remain fixed so the arcs N₈N₁, N₁N₂, and N₂N₃, in contrast, the rest of arcs will rotate about their own rotation axis of screws, i.e., O₁ or O₂, as shown in FIG. 2.

More exactly, the central angle of arcs M₂M₃ and M₈M₁ are all β, the central angle of arc M₄M₅ and M₆M₇ are all γ, and the central angle of arc M₃M₄ and M₇M₈ are φ1 and φ2. The arc M₅M₆ corresponds to the baffle, which has radius h, where d/2≦h<D/2 . The central angle of M₅M₆ is ε, which is symmetrical about O₁A, and the angle between axis O₁A and axis O₁M₃ equals the polar angle θ, where θ varies with an increase of axial position z, wherein 0≦z≦L, where L denotes the pitch of the first and the second screws. θₘᵢₙ≦θ≦θₘₐₓ, where

$${θ}_{min} = \frac{α}{2} + \frac{ɛ}{2} + β + γ$$

$$and$$

$${θ}_{max} = 2 π - ( α + 2 β + γ + \frac{ɛ}{2} ) .$$

The angle θ shows cyclic variation with an increase of axial position z, as shown below,

$$\begin{matrix}θ = {θ}_{min} + \frac{{θ}_{max} - {θ}_{min}}{{z}_{*}} z , z \leq {z}_{*} , & \\ Or , & \\ θ = {θ}_{min} + \frac{{θ}_{max} - {θ}_{min}}{{z}_{*} - L} ( x - L ) , z \geq {z}_{*} & \\ θ = {θ}_{min} + \frac{{θ}_{max} - {θ}_{min}}{{z}_{*}} z , z \leq {z}_{*} , & \end{matrix}$$

where z* corresponds to the axial position of θₘₐₓ, where 0<z*<L, and z*/L=0.5˜0.62 is preferred. The height of the baffle remains constant with an increase of its axial position.

The arc M₁M₂ in the first screw is engaged with the N₁N₂ arc in the second screw, as is M₂M₃ with N₂N₃, M₃M₄ with N₃N₄, and so on. Therein, the arc N₅N₆ is symmetrical about the axis O₂B, and the phase difference between the axis O₂B and O₁A is π, where the arc N₃N₄ and N₇N₈ are engaged with the inner cavity of the barrel.

The centerline distance between O₁, the rotation center of the first screw (3), and O₂, the rotation center of the second screw (4), is C, and the maximum diameters of the first and second screws is D. At the same time, the minimum diameter of the first and second screws is d, the angle degree for the arc M₂M₃ and M₈M₁ in the first screw is equal to β, where

$$β = 2 arccos ( \frac{C}{D} ) ;$$

thus, the angle for the arc N₂N₃ and N₈N₁ in the second screw is also equal to β. The angle for the arc M₄M₅ and M₆M₇ in the first screw is equal to γ, where

$$γ = π - arc cos ( \frac{{d}^{2} + 4 {h}^{2} - 4 Cd}{4 ( 2 C - d ) h} ) ,$$

such that the angle for the arc N₄N₅ and N₆N₇ in the second screw is also equal to γ.

The arc M₁M₂ has a radius value of D/2 and is centered at O₁, the rotation center of the first screw. The arcs M₃M₄ and M₇M₈ have the same radius values, d/2, and their centers are all O₁, the rotation center of the first screw. The arc M₂M₃ has the radius value C and is tangential to the circle, which is centered at O₁ and has the radius value d/2 at the point M₃. Thus, the arc M₈M₁ has the radius value C and is tangential to the circle, which is centered at O₁ and has the radius value d/2 at the point M₈. The arc M₄M₅ has the radius value C and is tangential to the circle, which is centered at O₁and has the radius value d/2 at the point M₄. Thus the arc M₆M₇ has the radius value C and is tangential to the circle, which is centered at O₁and has the radius value d/2 at the point M₇. The arcs N₃N₄ and N₇N₈ have the radius value D/2 and their center are all at O₂, the rotation center of the second screw. The arc N₁N₂ has the radius value d/2 and is centered at O₂, the rotation center of the second screw. The arcs N₂N₃ and N₈N₁ have the same radius value C and are tangential to the circle, which is centered at O₁ and has the radius value d/2 at the points N₁ and N₂. The arcs N₄N₅ and N₆N₇ have the same radius value C and are tangential to the circle, which is centered at O₂ and has the radius value d/2 at the points N₅ and N₆. The arc N₅N₆ has the radius value C-h and is centered at O₂, the rotation center of the second screw.

Meanwhile, D/d=1.1˜5.5; and L, the first and the second screws, is equal to 0.01D 100000D.

The self-cleaning and extruding method by co-rotating two screws with an internal baffle carried out by the above-mentioned apparatus is comprised of the following steps.

(1) After the materials enter the barrel from the feeding port, the first screw and second screw co-rotate along their own axes. When the materials enter the solid conveying zone, the feed material is pushed forward, partially under the positive displacement of the first and the second screw and partially by friction forces from the first and second screw, so that the materials are forced to move toward the melting zone. At the same time, the mixing of components from the first and second screw is achieved due to the action of the baffle in the first screw.

(2) When the materials move to the melting zone, heat transfer is enhanced because of the stir action of the baffle in the first screw channel. Compression action is exerted on the materials and pre-melting is achieved due to the action of the compression energy of the second screw. Meanwhile, friction heat is generated by the high speed rotation of each of the screws. At the same time, external heat is conducted through the barrel.

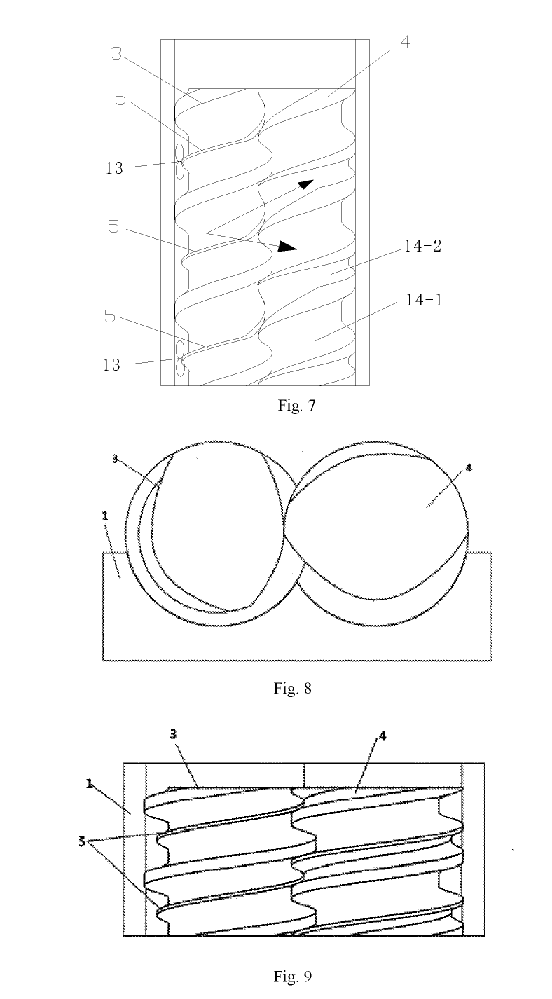

Topological chaos is also introduced into the screw channel by the mechanism ‘one part divided into two parts (as indicated by the arrow in FIG. 5), then two parts converging into one part (as indicated by the arrow in FIG. 6), and then one part divided into two parts once more’ (as indicated by the arrow in FIG. 7). In addition, the cross-section of the flow channel will undergo the ‘expansion (as indicated by the label 14-1 in FIGS. 5 to 7)—compression (as indicated by the label 14-2 in FIGS. 5 to 7)—expansion’ action, and the separation of the melt from the solids is accelerated. At the same time, the baffle in the first screw will cause hyperbolic flow perturbation in the shape of a ‘figure 8’ (as indicated by the label 13 in FIGS. 5 to 7) to generate chaotic mixing. All of these actions work together to accelerate the melting process such that the materials become a cohesive melt.

When the melt enters the venting zone, the single one-flow channel in the first screw is communicated with the two independent channels separated by the screw flight in the second screw, such that the surface area of venting is increased. Furthermore, the stir action of the first screw, and the compression and expansion action of the second screw, will accelerate gas to discharge from the venting port, and the melt to move further toward the discharge port.

When the melt enters the mixing and extruding zone, the melt is subjected to the topological chaos that is a result of the flow channel, which consists of two screws and a barrel, where the action of “one part divided into two parts, then two parts converging into one part, and then one part divided into two parts once more” is effective. The baffle in the first screw channel will induce hyperbolic perturbation in the shape of a ‘figure 8’ to generate global chaotic mixing throughout the whole screw channel. In addition, the periodic compression action will lead to elongational flow. These three effects will improve the mixing and plasticating of materials so that the melt is stably extruded from the discharge port. At the same time, a self-cleaning effect will be achieved by the inter-wiping effect between each of the screws.

### Embodiment 2

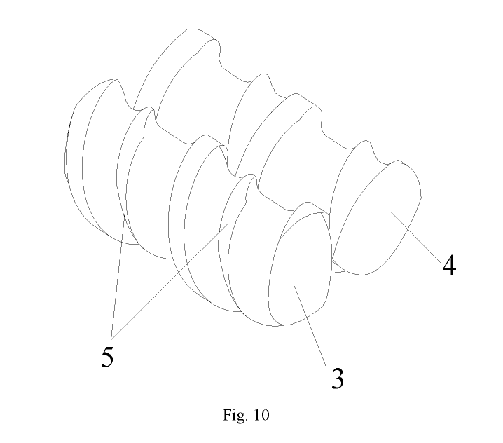

The present embodiment has the same structure as that of embodiment 1, except that the polar angle of the baffle remains constant with the variation of its axial position. The structural schematic diagram of the screw mechanism and partial barrel is shown in FIGS. 8 and 9.

### Embodiment 3

The present embodiment has the same structure as that of embodiment 1, except for the following features: the polar angle of the baffle experiences non-linear cyclic changes with the variation of its axial position and meets the terms of the following function:

$$θ = {θ}_{min} + ( {θ}_{max} - {θ}_{min} ) sin \frac{z π}{L} , 0 \leq z \leq L .$$

### Embodiment 4

The present embodiment has the same structure as that of embodiment 1, except for the following features: the polar angle of the baffle experiences non-linear cyclic changes with the variation of its axial position and meets the terms of the following function:

$$θ = {θ}_{min} + \frac{4 ( {θ}_{max} - {θ}_{min} )}{{L}^{2}} ( zL - {L}^{2} ) , 0 \leq z \leq L .$$

### Embodiment 5

The present embodiment has the same structure as that of embodiment 1, except for the following features: the polar angle of the baffle experiences non-linear cyclic changes with the variation of its axial position, and meets the terms of the following function:

$$\begin{matrix}θ = {θ}_{min} + \frac{3125 ( {θ}_{max} - {θ}_{min} ) {z ( L - z )}^{4}}{256 {L}^{5}} , 0 \leq z \leq L , & \\ or & \\ θ = {θ}_{min} + \frac{3125 ( {θ}_{max} - {θ}_{min} ) {z}^{4} ( L - z )}{256 {L}^{2}} , 0 \leq z \leq L . & \end{matrix}$$

### Embodiment 6

The present embodiment has the same structure as that of embodiment 1, except for the following features: the height of the baffle experiences non-linear cyclic changes with the variation of its axial position, and meets the terms of the following function:

$$\begin{matrix}h ( z ) = \frac{d}{2} + \frac{( \sqrt{5} - 1 ) ( D - d )}{2 L} ( \frac{L}{2} - z ) 0 \leq z \leq \frac{L}{2} , & \\ or & \\ h ( z ) = \frac{d}{2} + \frac{( \sqrt{5} - 1 ) ( D - d )}{2 L} ( z - \frac{L}{2} ) z \geq \frac{L}{2} . & \end{matrix}$$

The screw mechanism is shown in FIG. 10.

### Embodiment 7

The present embodiment has the same structure as that of embodiment 1, except for the following features: the height of the baffle experiences non-linear cyclic changes with the variation of its axial position, and meets the terms of the following function:

$$h ( z ) = \frac{d}{2} + \frac{2 ( D - d )}{5} {cos}^{2} \frac{z π}{L} 0 \leq z \leq \frac{L}{2} .$$

Each of the embodiments described above is the preferred embodiment of the present invention. However, the embodiments of the present invention are not limited to the above-mentioned embodiments; any other changes, modifications, substitutions, combinations, or simplifications made without departing from the spirit and principle of the present invention are all equivalent replacement modes and should be encompassed within the protection scope of the present invention.

1. A co-rotating, self-cleaning extruder with two screws and an internal baffle is comprised of a screw mechanism and a barrel; Said screw mechanism is provided inside of the inner section of the barrel, and placed horizontally; Said screw mechanism is comprised of the first screw and the second screw, where the axes of the first and second screws are coincidental with that of the barrel, the first screw has a one-tip configuration, the second screw has a two-tip configuration, and the first screw has an internal baffle, which is lower than the screw flight and can cause a hyperbolic perturbation in the shape of a ‘figure 8’ flow manifold; The first and second screws co-rotate at the same speed and keep in touch with each other at all times; The first screw and the baffle achieve the self-cleaning function with the channel of the second screw, and the second screw achieves the self-cleaning function with the channel of the first screw.

2. A co-rotating, self-cleaning extruder with two screws and an internal baffle in accordance with claim 1, characterized by the outer sides of the first screw and the second screw being tangential to the inner side of the barrel cavity, and the flow channel formed between the first screw, the second screw, and the inner side of the barrel.

3. A co-rotating self-cleaning extruder with two screws and an internal baffle in accordance with claim 1, characterized in that the cross-sections of the first and second screws are comprised of several circle arcs of different radii, and the number of circle arcs of the first and second screws are the same.

4. A co-rotating self-cleaning extruder with two screws and an internal baffle in accordance with claim 3, characterized in that the cross-section of the first and second screws are comprised of eight circle arcs of different radii, where the arcs of the first screw are M₁M₂, M₂M₃, M₃M₄, M₄M₅, M₅M₆, M₆M₇, M₇M₈, and M₈M₁; and the arcs of the second screw are N₁N₂, N₂N₃, N₃N₄, N₄N₅, N₅N₆, N₆N₇, N₇N₈, and N₈N₁;
The arc M₁M₂ is engaged with the arc N₁N₂; Correspondingly, M₂M₃ is engaged with N₂N₃, M₃M₄ with N₃N₄, M₄M₅ with N₄N₅, M₆M₇ with N₆N₇, M₇M₈ with N₇N₈, and M₈M₁ with N₈N₁.

5. A co-rotating self-cleaning extruder with two screws and an internal baffle in accordance with claim 4, characterized in that the rotation center of the first screw is O₁, arc M₅M₆ corresponds to the baffle, the polar angle of the baffle experiences cyclic changes or non-cyclic changes, and the polar angle is the angle between the centerline of the baffle and axis O₁M₃.

6. A co-rotating self-cleaning extruder with two screws and an internal baffle in accordance with claim 4, characterized in that the rotation center of the first screw is O₁, arc M₅M₆ corresponds to the baffle, the polar angle of the baffle is constant, and the polar angle is the angle between the centerline of the baffle and axis O₁M₃.

7. A co-rotating self-cleaning extruder with two screws and an internal baffle in accordance with claim 4, characterized by the first screw, where the height of the baffle is constant, or experiences cyclic changes with the increase of the corresponding axial position.

8. A co-rotating self-cleaning extruder with two screws and an internal baffle in accordance with claim 1, characterized in that the inner cavity of the barrel consists of two cylindrical grooves which are communicated, whose cross-section appears as a hole in the shape of a ‘figure 8’.

9. A co-rotating self-cleaning extruder with two screws and an internal baffle in accordance with claim 1, characterized in that according to the motion direction of the materials to be processed, the inner section of barrel 1 is divided into a solid transporting zone, a melting zone, a venting zone, and a mixing and extruding zone; said feeding port is located above the barrel of the solid transporting zone, said venting port is located above the barrel of the venting zone, both the feeding port and the venting port are communicated with the barrel, and said discharge port is located at the end of the barrel.

10. A co-rotating self-cleaning extruder with two screws and an internal baffle in accordance with claim 1, characterized by the following steps:
(Step 1) After the materials enter the barrel from the feeding port, the first screw and second screw co-rotate along their own axes; When the materials enter the solid conveying zone, the feed materials are pushed forward, partially under the positive displacement of the first and second screws and partially by the friction forces from the first and second screws, so that the materials are forced to move toward the melting zone; At the same time, the mixing of components from the first and second screws is achieved due to the action of the baffle in the first screw;
(Step 2) When the materials move to the melting zone, heat transfer is enhanced because of the stir action of the baffle in the first screw channel; Compression action is exerted on the materials and pre-melting is achieved due to the action of compression energy of the second screw; Meanwhile, friction heat is generated by the high speed rotation of each of the screws and, at the same time, external heat is conducted through the barrel;
Topological chaos is also introduced into the screw channel by the mechanism ‘one part divided into two parts, then two parts converging into one part, and then one part divided into two parts once more’; In addition, the cross-section of the flow channel will undergo the ‘expansion—compression—expansion’ action, and the separation of melt from solids will be accelerated; At the same time, the baffle in the first screw will cause hyperbolic flow perturbation in the shape of a ‘figure 8’ to generate chaotic mixing; All of these actions work together to accelerate the melting process, so that the materials become a cohesive melt;
(Step 3) When the melt enters the venting zone, the single one-flow channel in the first screw is communicated with the two independent channels, which are separated by the screw flight in the second screw, so that the surface area of venting is increased; Furthermore, the stir action of the first screw, and the compression and expansion action of the second screw, will accelerate gas to discharge from the venting port, causing the melt to move further toward the discharge port;
(Step 4) When the melt enters the mixing and extruding zone, the melt is subjected to the topological chaos from the flow channel, which consists of two screws and the barrel, where the action of “one part divided into two parts, then two parts converging into one part, and then one part divided into two parts once more” is effective; The baffle in the first screw channel will introduce hyperbolic perturbation in the shape of a ‘figure 8’ to generate global chaotic mixing throughout the whole screw channel; In addition, the periodic compression action will lead to elongational flow; These three effects will improve the mixing and plasticating of materials so that the melt can be stably extruded from the discharge port; At the same time, a self-cleaning effect is achieved by the inter-wiping effect between each of the screws.
